(19) United States
(12) Patent Application Publication
(10) Pub. No.: US 2015/0336680 A1
(43) Pub. Date: Nov. 26, 2015

(54) Tank System For The Cryogenic Storage Of Hydrogen, And Aircraft With A Tank System For The Cryogenic Storage Of Hydrogen

(71) Applicant: Airbus Operations GmbH, Hamburg (DE)

(72) Inventors: Markus Schumacher, Hamburg (DE); Claus Hoffjann, Hamburg (DE); Frank Lehmberg, Hamburg (DE)

(73) Assignee: Airbus Operations GmbH, Hamburg (DE)

(21) Appl. No.: 14/718,229

(22) Filed: May 21, 2015

(30) Foreign Application Priority Data
May 23, 2014 (DE) 10 2014 107 316.9

(51) Int. Cl. B64D 37/06; B64D 37/32

(52) U.S. Cl. CPC B64D 37/06; B64D 37/32

(57) ABSTRACT

A tank system for the cryogenic storage of hydrogen includes a tank structure with at least one hollow body for accommodating liquid hydrogen and at least one insulating means, which encloses the tank structure, for insulating the at least one hollow body. The tank structure has an exterior shape that is integrateable in a load-bearing primary structure of an aircraft. The tank structure is load bearing and is designed to at least partially absorb a load introduced into the primary structure. This makes it possible to achieve a particularly efficient design of an aircraft in which the fuselage of the aircraft is not divided into two parts by the hydrogen tank integrated therein, can be arranged near the center of gravity, and essentially does not increase the additional weight of the aircraft.

### TECHNICAL FIELD

The invention relates to a tank system for the cryogenic storage of hydrogen and to an aircraft with a tank system, installed therein, for the cryogenic storage of hydrogen.

### BACKGROUND OF THE INVENTION

The operation of hydrogen-consuming devices in vehicles makes it necessary to carry hydrogen along or to continuously produce it. If large volume flows or mass flows of hydrogen are required by means of which, for example, turbojet engines or fuel cells of a high nominal output are operated, the carrying along of cryogenic hydrogen is almost unavoidable. A vessel for storing cryogenic hydrogen over a particular period of time not only requires adequate insulation, because liquid hydrogen has a temperature of −253° C. or less, but also adequate pressure resistance of the tank concerned. Vacuum insulation can provide adequate insulation for such a tank, wherein its efficiency is, in particular, increase by the provision of a particularly small surface relative to the volume.

However, the integration of a tank for storing cryogenic hydrogen, for example in an aircraft with limited space available, which aircraft nevertheless has a substantial requirement of hydrogen, poses a technical challenge.

The Airbus project “Cryoplane” provided for the use of liquid hydrogen as a fuel replacement for kerosene. In order to make it possible for the cabin to be used along its entire length, cylindrical pressure tanks were accommodated outside a given fuselage cross section. The pressure tanks were accommodated along an upper fuselage contour line and were provided with an aerodynamically favorable fairing that ensures a soft transition to the actual fuselage. This is associated with a disadvantage as a result of the inevitably increased front surface and the resulting increase in the aerodynamic resistance, or drag, of the aircraft.

In a Russian project study the arrangement of a cylindrical pressure tank for storing liquefied natural gas in a rearward region of an aircraft fuselage was investigated in a Tupolev TU155. In this arrangement the space available for passengers in the aircraft fuselage was reduced, because the pressure tank almost completely takes up the available cross section.

### BRIEF SUMMARY OF THE INVENTION

A conventional design of cryogenic hydrogen tanks, which tanks are essentially based on cylindrical pressure tanks, in the state of the art is associated with a reduction in the available cabin volume, an increase in the aerodynamic resistance, or positioning substantially outside the center of gravity of the aircraft.

Accordingly an aspect of the invention proposes a tank system for the storage of cryogenic hydrogen, which tank system allows storage near the center of gravity of an aircraft while at the same time not limiting or dividing the available space within the aircraft fuselage, is able to adapt as far as possible to the available design space, and does not impede the aerodynamic characteristics of the aircraft.

Proposed is a tank system for the cryogenic storage of hydrogen, with the tank system comprising a tank structure with at least one hollow body for accommodating liquid hydrogen and at least one insulating means, which encloses the tank structure, for insulating the at least one hollow body. The tank structure comprises an exterior shape that is integrateable in a load-bearing primary structure of an aircraft, and wherein the tank structure is load bearing and is designed to at least partially absorb a load introduced into the primary structure.

The tank structure with the at least one hollow body is a functional element of the tank system and provides a volume for storing the hydrogen. The number of hollow bodies is not limited, i.e. apart from a single hollow body the tank structure may also comprise a multitude of hollow bodies that together result in the desired tank structure with the desired shape. Furthermore, it would of course also be possible to provide several individual tank structures distributable over an aircraft and in each case supplementing or supporting a part of the primary structure.

The shape of the tank structure is matched in such a manner that complete integration into the primary structure becomes possible. In this context, the term “integration” refers to the incorporation of the tank structure in the primary structure, which incorporation goes beyond the attachment of a tank to a primary structure, in particular forms an integral part of the primary structure, and in cooperation with the remaining part of the primary structure provides the entire load-bearing function of a primary structure. In this design it is imaginable that the tank structure completely replaces a section or a detachable part of a primary structure and assumes the same load-bearing function while comprising a compatible, but not necessarily identical, shape to that of the structure to be replaced. Apart from the actual shape of the tank structure, which matches the primary structure of an aircraft fuselage or of a wing, adequate strength for ensuring the load-bearing function is also necessary.

The tank structure comprises, in particular, an exterior shape that can be integrated in a load-bearing primary structure of at least one of an aircraft fuselage and a wing of an aircraft. In this design, shape adaptation takes place, in particular, for integration in a fuselage and/or in a wing of an aircraft.

A core concept of the invention thus relates to the provision of a tank system with a tank structure that is able to at least partly assume a load-bearing function of a primary structure without, however, comprising exterior dimensions or an exterior shape that requires an increased front surface of the aircraft, or that limits the available space within the fuselage. As is shown in the embodiments presented below, integration into the primary structure may be achieved in many different ways, each being very advantageous per se. Apart from a concentric, hollow-cylindrical design within an aircraft fuselage, individual pressure tanks that are packed in the manner of bundles, in wing structures or within an aircraft fuselage outside of passenger cabins may also be considered.

Apart from the actual hollow bodies or the tank structure, the tank system may comprise further components that may be necessary for conveying and regulating the flow of gaseous hydrogen. The term “tank structure” refers to the component that is provided for the actual storage of the hydrogen and that comprises at least one hollow body. The latter may comprise several pressure vessels. If the tank structure comprises only a single hollow space and/or a single pressure vessel, these three terms may also be used synonymously, wherein the terms “pressure vessel” and “hollow body” may be used synonymously also in the case of several hollow bodies, because each pressure vessel should also be a hollow body.

In an advantageous embodiment the at least one first hollow body is a hollow cylinder that forms a longitudinal section of the primary structure of an aircraft fuselage. In this context it should be noted that in reality a hollow cylinder does not necessarily have to have a circular cross section. Instead, the cross section may also be oval, rounded or polygonal, wherein the exterior shape of the hollow cylinder matches the desired shape of the aircraft fuselage. Accordingly, the tank structure as a longitudinal section of the aircraft fuselage carries the liquefied hydrogen in a volume that extends in a ring-shaped manner on a center axis, while due to the cutout along the center axis a hollow shape and thus a passage in the axial direction is possible. Thus the tank structure may have a center of gravity that is to be arranged as closely as possible to the center of gravity of the aircraft, wherein the tank structure extends in the axial direction along the aircraft fuselage. Parts of the original primary structure, in other words frame elements, longitudinal stringers and the like, may at least in part be replaced or supplemented by the tank structure. Apart from the integration of several functions in one component, the above is associated with a particular advantage in that despite the provision of a tank near the center of gravity no fuselage regions are blocked to such an extent that two separate cabin halves would arise. It is thus possible without further ado for passengers to move from one longitudinal end of the tank structure to another longitudinal end of the tank structure.

As a matter of course the tank structure may comprise additional stiffening elements that make it possible to achieve an even more reliable load-bearing function. Said elements may be arranged on the outside of the tank structure, likewise between an exterior and an interior jacket surface of the tank structure. For example, longitudinal ribs may extend between an exterior and an interior jacket surface of a hollow-cylindrical tank structure in the longitudinal direction of the aircraft fuselage, wherein, for the purpose of saving weight and for interconnecting the tank segments divided by the incorporation of stiffening ribs, said longitudinal ribs comprise several apertures or are perforated. The incorporation of stiffening elements may comprise the separate manufacture of components of a tank segment and the subsequent assembly. As an alternative or in addition to this, individual components or the entire tank structure may also be produced with the use of a generative manufacturing method.

In an advantageous embodiment the at least one first hollow body comprises an arrangement of several closed-off pressure vessels which in each case comprise at least one aperture that is in fluidic communication with an aperture of an adjacent pressure vessel. As a result of the division of the tank structure into several individual pressure vessels it is significantly easier to manage high hydrogen pressure with thin walls of the pressure vessels, because according to Barlow's formula the wall thickness of a cylindrical tank is approximately proportional to the interior diameter of the tank. Depending on the size and/or number as well as the stack arrangement of the pressure vessels used, practically any desired spatial shape may be implemented, which pressure vessels then form part of the primary structure of an aircraft fuselage or aircraft wing. The division of a required total volume into several partial volumes requires connections among the individual pressure vessels, which in this embodiment is achieved by means of at least one aperture provided in a pressure vessel, which aperture is in fluidic communication with an aperture of an adjacent pressure vessel. Consequently it may be sufficient to remove hydrogen only from a single closed-off pressure vessel, because said pressure vessel is always replenished by way of the communicating pressure vessels, or is supplied with hydrogen in the liquid or gaseous state as a result of the pressure arising during heating.

In a particularly advantageous embodiment, the arrangement of several closed-off pressure vessels is an arrangement of several interconnected elongated tubes of a round or polygonal cross section. Normally, the length of tubes significantly exceeds their diameter, so that tubes are approximately shaped as a cylindrical tank. The use of an arrangement of several such tubes makes it possible to manufacture a dense package of tubes that form a volume that is usable as a primary structure or is integrated in a primary structure. The tubes are interconnected in such a manner that their volumes complement each other. In this arrangement the tubes may be arranged in a regular manner so that the tubes only form columns and lines that exclusively comprise intersecting planes. However, it would also be possible to generate an arrangement in which tubes of a second layer rest on the interspaces of tubes of a first layer in the form of a dense package, forming only relatively small interspaces.

In a particularly advantageous embodiment the tubes comprise a hexagonal profile and are designed to form a dense package without interspaces. With the use of a hexagonal profile, two beveled wall faces that are oriented so as to be symmetrical relative to each other follow a straight base area. In the case of a hexagonal profile this arrangement is mirror symmetrical. This means that a base of a hexagonal profile and directly adjacent beveled surfaces can conform so as to be flush in the indentation formed by two adjacent hexagonal profiles of a layer situated underneath. In this manner a multitude of tubular pressure vessels may be provided that form a particularly dense package, wherein because of the absence of interspaces its efficiency is very high. The achievable shapes are very flexible, and as a result of the profile shape and their mutual conforming also very strong.

In a further advantageous embodiment the tubes are stacked on top of each other so as to be parallel to each other in a dense package, and the shape of the tank structure is determined by the sequence of the parallel layers and of the individual length of the individual tubes. In this manner it is possible to produce bodies of any shape, including spherically-shaped bodies, in that the lengths of the tubes in all the individual layers match the exterior contour of the tank structure, which exterior contour is to be achieved.

It is furthermore advantageous to arrange several closed-off pressure vessels to form an arrangement of several interconnected spherical vessels. The tank structure may thus be created by means of a dense spherical pack, wherein the size of the individual spherical vessels determines the fineness of the exterior contour and of the tank structure that is manufacturable with it. In contrast to the situation with stacked tubes, gradation may be achieved in practically all spatial directions, while tubes, due to their elongated shape, are particularly well suited to elongated or at least partially cuboid tank structures.

If spherical pressure vessels are used, it may make sense to selectively empty the individual layers from the outside towards the inside, in the manner of an onion-skin principle, in order to achieve an insulating effect from the outer, empty, layers of spherical pressure vessels, which insulating effect complements an insulating material that encloses a tank structure. Selective emptying may be achieved with the use of valves that interconnect the individual pressure vessels, wherein the valves are controlled by a control unit designed to close off or establish in a layered manner the connection between individual pressure vessels.

Adjacent pressure vessels are preferably bonded together so that the resulting structure remains stable. Bonding may, in particular, comprise the use of a thermosetting adhesive or resin, which provide particularly high strength in a wide temperature range.

As an alternative or in addition to this it may also make sense to enclose the arrangement with a gas-proof and evacuated envelope so that the pressure vessels are enclosed flush by the envelope, and as a result of evacuation are pressed to form a rigid bundle. In particular from foodstuff packages or from shapeable rescue stretchers for the transport of patients in a manner that protects the spinal column, it is known to form loose bulk objects in an evacuable elastic vessel by suction removal of air and by airtight closure together with the vessel, thus obtaining a very compact rigid unit. Because of the vacuum, the bulk objects are jammed together and can no longer move.

Advantageously, interspaces between adjacent pressure vessels are sealed off in a gas-proof manner and are designed to receive or deliver hydrogen as required. In the dense package of individual pressure vessels, which preferably have a round cross section, interspaces between the individual pressure vessels always remain. Said interspaces may also be used for receiving hydrogen, for example by bonding the adjacent pressure vessels and consequently the gas-proof nature of the interspaces. In addition, the pressure of the hydrogen in the interspaces acts on the exterior surfaces of the individual pressure vessels so that this counteracts the stress on the pressure vessels.

In a tank system the at least one hollow body may also comprise an exterior wall that extends over a spatial lattice structure. The term “spatial lattice structure” refers to a compound structure comprising regularly arranged struts that for receiving bending loads, compressive loads, shear loads and tensile loads project in all spatial directions, and in the manner of a framework result in particularly high overall strength of the hollow body. The struts preferably extend through the entire hollow body, which may be manufactured, component by component, supported by a casting process or completely by means of a generative manufacturing method. The latter is the preferred variant, because it makes it possible to achieve lattice structures of any complexity.

In this arrangement the lattice structure may also comprise groups of struts that are arranged at angles to each other, wherein each group comprises a common nodal point, and outwards-projecting struts of adjacent groups are interconnected. In this manner larger clearances within the hollow body may be bridged without the need to provide excessively long struts, which would then have to be of adequate strength. Instead, shorter struts may support themselves on the nodal points.

The insulating means preferably comprises a multi-layer evacuable insulating envelope, wherein at least two layers in the form of an interior envelope and an exterior envelope are spaced apart from each other by means of spacers. In particular, vacuum insulation in which two envelopes are spaced apart from each other and the interspace is evacuated lends itself for the insulation of hydrogen vessels or other cryogenic tanks, because heat transfer through a vacuum is significantly reduced when compared to other insulating materials. If the above-mentioned embodiment is selected, pressing of the individual pressure vessels may take place by evacuation of the interior envelope of the insulating envelope. In addition, the space between the interior envelope and the exterior envelope is evacuated.

Preferably, the spacers may be implemented by a honeycomb core. Honeycomb materials may be formed relatively well under the influence of pressure and heat. Within certain limits, unwindably curved surfaces of a honeycomb material, in particular comprising a thin-walled metallic material or an elastomer, may even be deformed spherically. In the manufacture of window panels for aircraft cabins a method based on the above is used, which method by a corresponding selection of materials and matching strength is transferable to the envelope of curved surfaces, for example a tank made from composite tubes. Orientation of the honeycombs may be along, across, or vertical to, the direction of flight. The honeycomb structure of a so-called crush core is, however, arranged so as to be essentially perpendicular to the boundary surfaces of the tank volume, thus maintaining the distance between two or more cover layers of the thermal insulating means.

It is also possible to use a three-dimensional micro-grid as a spacer or as stiffening of a pressure vessel, which micro-grid provides a lattice structure between two or more boundary surfaces of the insulation and/or of a pressure vessel. The micro-grid may, in particular, comprise a multitude of interconnected rod-shaped or tubular tension elements and compression elements that are interconnected in the form of a three-dimensional grid. In the case of the insulating means it is desirable if the micro-grid may absorb compressive forces particularly well, whereas in the case of a pressure vessel it is more likely to be tensile forces. The micro-grid may, in particular, be implemented by means of a casting process involving lost wax casting, manufactured with the use of a lithography process, and the application of galvanic material. Furthermore, generative manufacturing methods or additive layer methods (ALM) suggest themselves, by means of which individual pressure vessels, including a micro-structure contained therein, are constructed layer by layer.

Generative manufacturing methods promise faster and significantly more economic manufacture and are suited not only to the described micro-grid structures but also to tube bundles of whatever cross section, and to spherical-shape structures. Also imaginable are transitional shapes between the described tube bundles of hexagonal cross section, and the above-mentioned three-dimensional micro-grids, in which walls are reduced to rod-shaped or filament-shaped structures, which remain, however, in the planes of the walls of the hexagonal tube compounds. With lighter weight, the characteristics of a hexagonal tube compound are largely maintained. It is precisely such structures that can be manufactured practically only by means of generative methods.

The invention further relates to an aircraft having a fuselage, at least one wing, a hydrogen-consuming device, and at least one such tank system for storing cryogenic hydrogen.

Integration of a tank structure in the at least one wing is particularly advantageous, wherein the tank structure comprises several tubes that are interconnected and stacked in a layered manner. The at least one insulating means encloses the entire arrangement of the tank structure.

In an advantageous improvement the tubes are arranged orthogonally to the leading edge of the wing or parallel to the longitudinal direction of the aircraft and comprise at least two different lengths in order to assume a shape that matches the contour of the wing.

In another embodiment the tubes are arranged parallel to the leading edge of the wing and comprise a shape that matches the contour of the wing.

### BRIEF DESCRIPTION OF THE DRAWINGS

Further characteristics, advantages and application options of the present invention are disclosed in the following description of the exemplary embodiments and in the figures. All the described and/or illustrated characteristics per se and in any combination form the subject of the invention, even irrespective of their composition in the individual claims or their interrelationships. Furthermore, identical or similar components in the figures have the same reference characters.

FIG. 1 shows a partial section of an aircraft with a hollow-cylindrical tank system that forms a primary structure.

FIG. 2 shows a partial section of an aircraft in which an aircraft fuselage is formed by a hollow-cylindrical tank system.

FIG. 3 shows an aircraft with rear engines and a backswept wing with a strong sweep, in which a cylindrical tank is arranged in an aft region.

FIG. 4 shows a wing with a tank system installed therein, with a multitude of tubular pressure vessels that extend orthogonally to a leading edge of the wing.

FIG. 5 shows a wing with a tank system installed therein, with a multitude of tubular pressure vessels that extend parallel to a leading edge of the wing.

FIG. 6 shows a tank system in an aircraft fuselage above a cabin.

FIG. 7 shows a design in a tank system with a dense package of pressure vessels.

FIG. 8 shows pressure vessels bonded together with approximately triangular interspaces, which receive hydrogen, and an insulating means.

FIG. 9 shows a somewhat reduced package density of pressure vessels that are stacked in a pure matrix arrangement.

FIG. 10 shows an arrangement of pressure vessels with hexagonal profiles without interspaces.

FIG. 11 shows an example of the manufacture of an arrangement of pressure vessels as shown in FIG. 10.

FIG. 12 further shows the integration of perforation apertures on facing surfaces of individual pressure vessels of the arrangement of FIGS. 11 and 12.

FIG. 13 shows pre-formed envelopes with a honeycomb core over a pressure tank arranged in a wing.

FIG. 14 discloses a three-dimensional micro-grid comprising several hollow micro-tubelets for stiffening a pressure tank.

FIGS. 15 and 16 each shows a structure of FIG. 14 in an insulating means and a pressure tank enclosed by it.

FIG. 17 shows an arrangement comprising several spherical pressure vessels that form a tank structure.

FIGS. 18a-18c show valve arrangements between pressure vessels of a tank system.

FIG. 19 shows a hollow body comprising several tubes with hexagonal profiles and a lattice structure formed on the walls.

### DETAILED DESCRIPTION

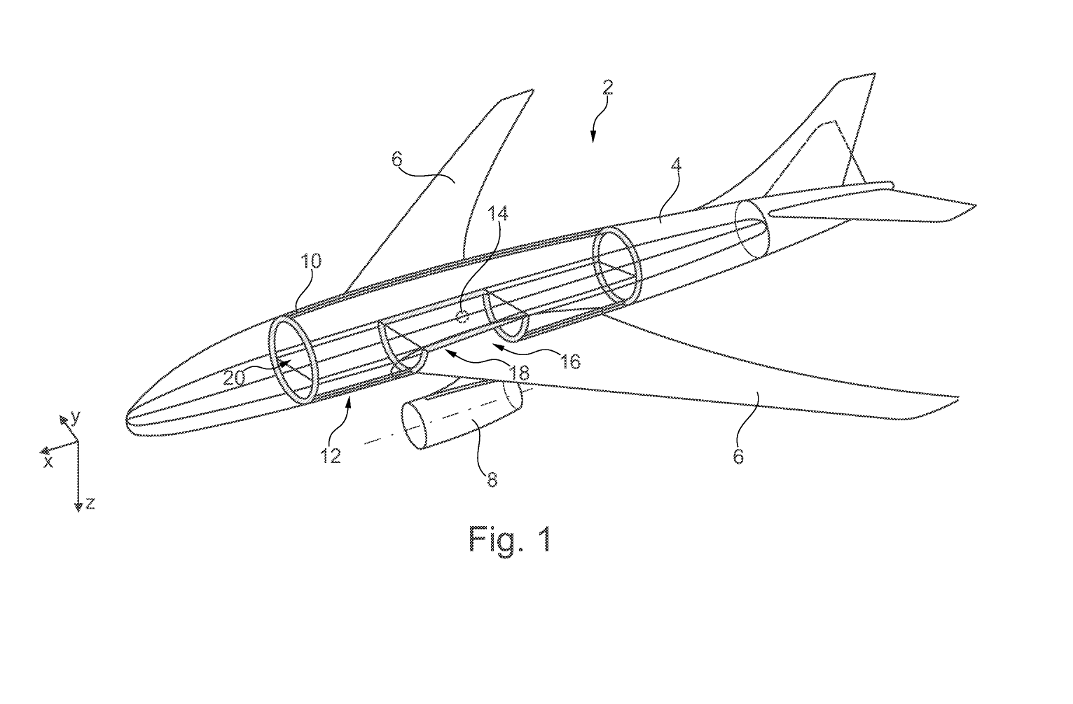

FIG. 1 shows an aircraft 2 with an elongated, essentially cylindrical, fuselage 4, wings 6 arranged thereon, and engines 8 arranged on the undersides of the wings 6. The aircraft fuselage 4 comprises a primary structure (not explicitly shown in FIG. 1) that extends over the entire fuselage 4. The primary structure is designed to ensure the structural stability of the fuselage 4 during all the operating phases of the aircraft 2.

Part of the primary structure is supplemented or replaced by a tank structure 10 of a tank system 12, wherein the tank structure 10 uniformly extends from the center of gravity 14 of the aircraft 2 in the longitudinal direction (x) both forwards, i.e. in the direction of the nose, and rearwards, i.e. in the direction of the tail, and is designed so as to be hollow cylindrical. The structural design of the tank structure 10 is to be matched in such a manner that the structural stability of the aircraft 2 is comparable to that of conventional aircraft. This may be achieved by the integration of stiffening elements in the hollow-cylindrical shape of the tank structure 10, and/or by a corresponding selection of the shape and the wall thicknesses, the tank structure and the division into several longitudinal sections that are independent of each other. In this illustration an insulating means that encloses the tank structure 10 is not shown i.e. has not been explicitly put in place.

In the region of a wing root 16 the tank structure 10 comprises a recess 18 that makes it possible to feed through a wing box and lines installed therein, kinematic elements for adjusting high-lift flaps, and the like. This region covering the wing root 16 may also be recessed so that forward or aft of this region a separate hollow-cylindrical tank structure is present.

The hollow-cylindrical shape provides a particular advantage in that a free interior cross section 20 results that is usable as a passage for passengers and crew. Thus, a cabin formed in the aircraft 2 would not be divided into two completely separate parts as a result of the arrangement of a concentric cylindrical tank. Thermal insulation towards the outside to the environment and towards the inside to the cabin must, however, ensure that the low temperature level of −253° C. is maintainable, at least for the duration of operation.

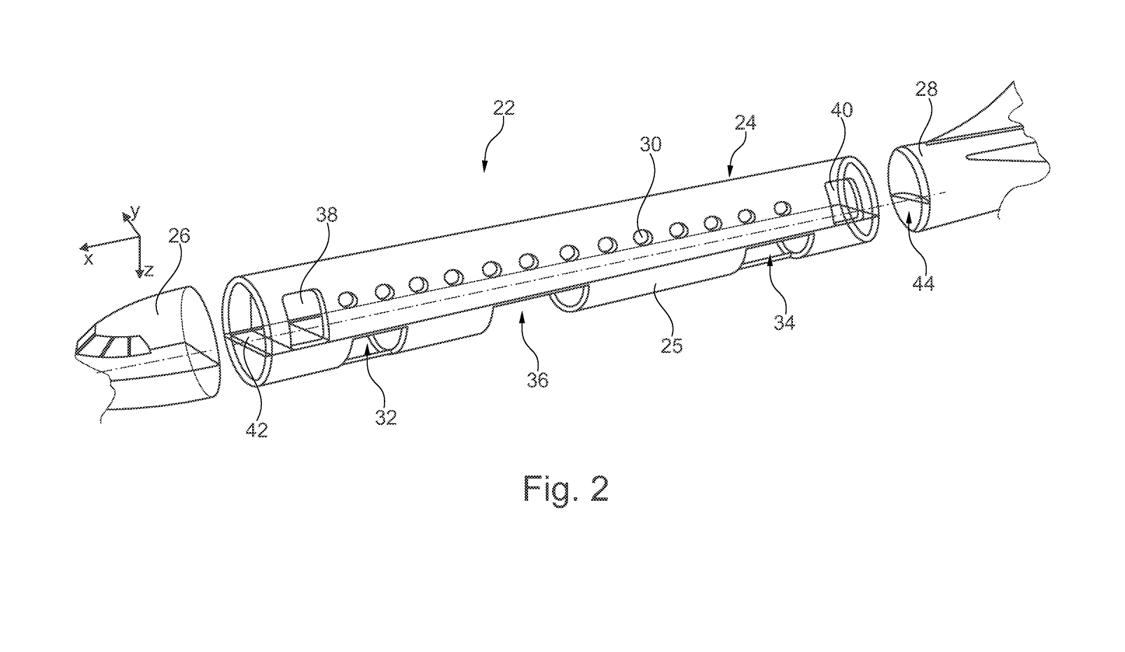

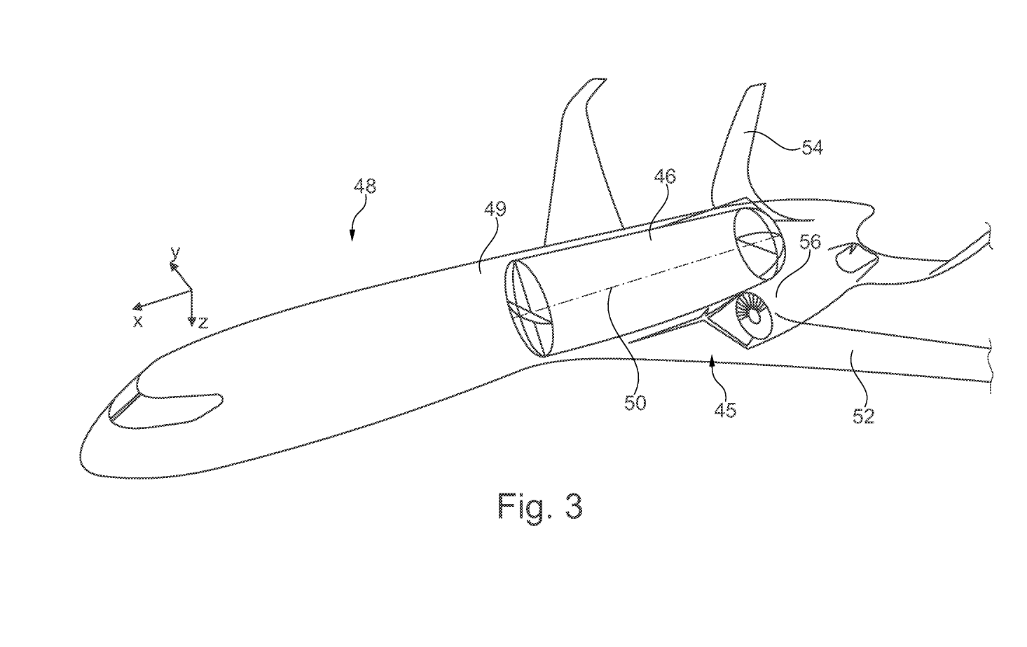

In FIG. 2 this approach is presented in still further detail. The illustration shows an aircraft fuselage 22 comprising a hollow-cylindrical tank system 24 and a cockpit 26 arranged thereon, a tail unit body 28, and wings (not shown) arranged on the aircraft fuselage 22. The tank system 24 thus forms the main part of the fuselage 22 and comprises a number of windows 30 and cutouts 32, 34 and 36 that make it possible to feed through a wing box (cutout 36) and to attach cargo doors (cutouts 32 and 34). Additional door cutouts 38 and 40 provide access to a cabin, and a passenger floor 42 is arranged directly in the tank system 24. The tank structure of the tank system 24 thus replaces the classical stiffened fuselage. In order to at least temporarily maintain the low temperature of the liquid hydrogen, an insulating means (not shown in detail) is used that is arranged on the outside and on the inside of the tank system 24.

The component referred to as the tail unit 28 is a part that completes the aircraft fuselage 22 and comprises a pressure bulkhead 44 that closes off a pressurized cabin in the interior of the tank system 24 towards the exterior. A vertical stabilizer and a horizontal stabilizer are arranged on a cone-shaped fuselage end.

In contrast to the above, a tank system with a fuselage-concentric fully-cylindrical tank structure 46 comprising a continuous overall volume may be integrated in an aircraft 48 with a center of gravity 50 that is located relatively far aft, as shown for example in the study “Future by Airbus”, with a strongly swept main wing 52 and combined wings and tail units 54 that are arranged on a tail cone of the aircraft 48. In an aft region the tank system 46 may structurally support the primary structure of the aircraft 48; said tank system 46 would be arranged already near engines 56 that are arranged aft.

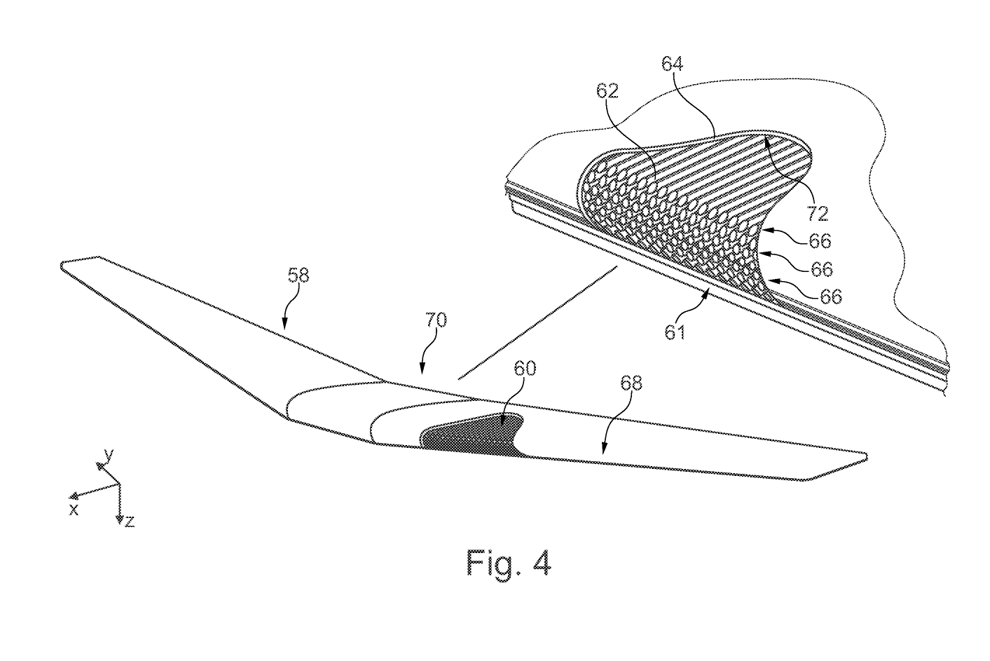

FIG. 4 shows an overall view and a detailed section of a wing 58. The wing 58 comprises a tank system 60 comprising a tank structure with a multitude of tubular pressure vessels 62 and an insulating means 64 that encloses this arrangement. In a common aircraft-fixed coordinate system, for example according to DIN 9300, the individual pressure vessels 62 extend parallel to the aircraft's longitudinal axis (x). Individual layers 66 are arranged stacked in such a manner that pressure vessels 62 rest against interspaces of two underlying pressure vessels 62. With the use of such a dense package arrangement a large part of the volume within the wing 58 can be made very good use of.

This design provides an advantage in that individual pressure vessels 62 may be dimensioned and manufactured taking into account the loads to be expected, without there being a need to predetermine the exterior shape of the tank system 60. As stated above, based on Barlow's formula a thin wall thickness may be achieved with a small interior diameter of the individual pressure vessels 62.

In contrast to the previous exemplary embodiments this design makes it possible to implement practically any geometric shape. The individual lengths of the individual pressure vessels 62 are matched to the desired profile shape, in particular of a leading edge 66 of the wing 58, and the layers are bonded together. Because of the individual dimensions of the pressure vessels 62 this design is particularly suited to the formation of a geometric shape that is essentially cuboid or comprises a cuboid core. With stacking in a pyramid-like shape it is also possible to manufacture wedge-shaped or other structures.

Each individual pressure vessel 62 is self-contained, but it should also have apertures by means of which it is connectable to other pressure vessels 62. It would then be sufficient, in particular in a central region of the wing 58, in other words near a wing root 68, to connect pressure vessels situated in that location to a hydrogen conveying system, where hydrogen is removed. Hydrogen from pressure vessels 62 situated on the exterior may stream-in in the direction of the wing root 68.

The pressure vessels 62 may be bonded together so that a closed solid block is formed. As an alternative or in addition to this it would, of course, also be possible to place part of the insulation 64, for example an interior envelope, or an additional envelope 72, around the pressure vessels 62, to design it so that it is gas-proof, and to evacuate it. In this manner the pressure vessels 62 are affixed in the assumed position and are pressed together as a result of the evacuation pressure.

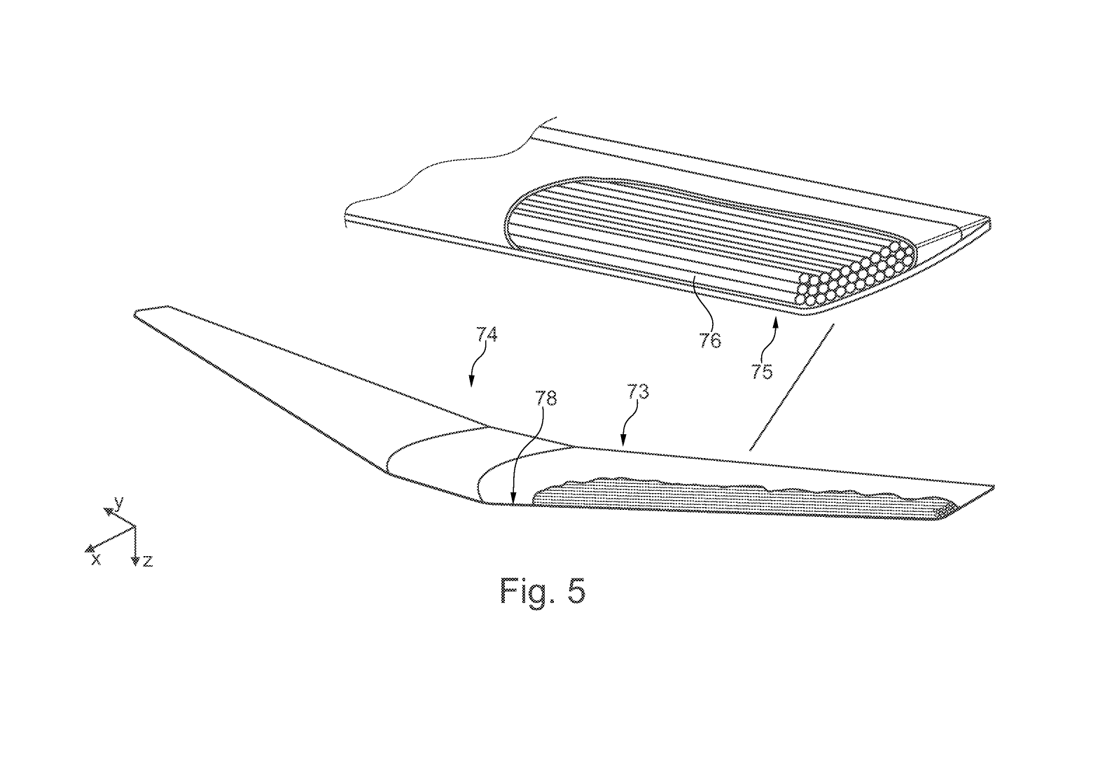

FIG. 5 shows a modification with reference to a wing 74 that also comprises individual tubular pressure vessels 76 which are, however, arranged in particular in exterior regions of the wing and extend so as to be parallel to a leading edge 78 of the respective leading edge. The number of pressure vessels 76 necessary for this tends to drop relative to that of the embodiment in FIG. 4, but in the latter they are longer in length.

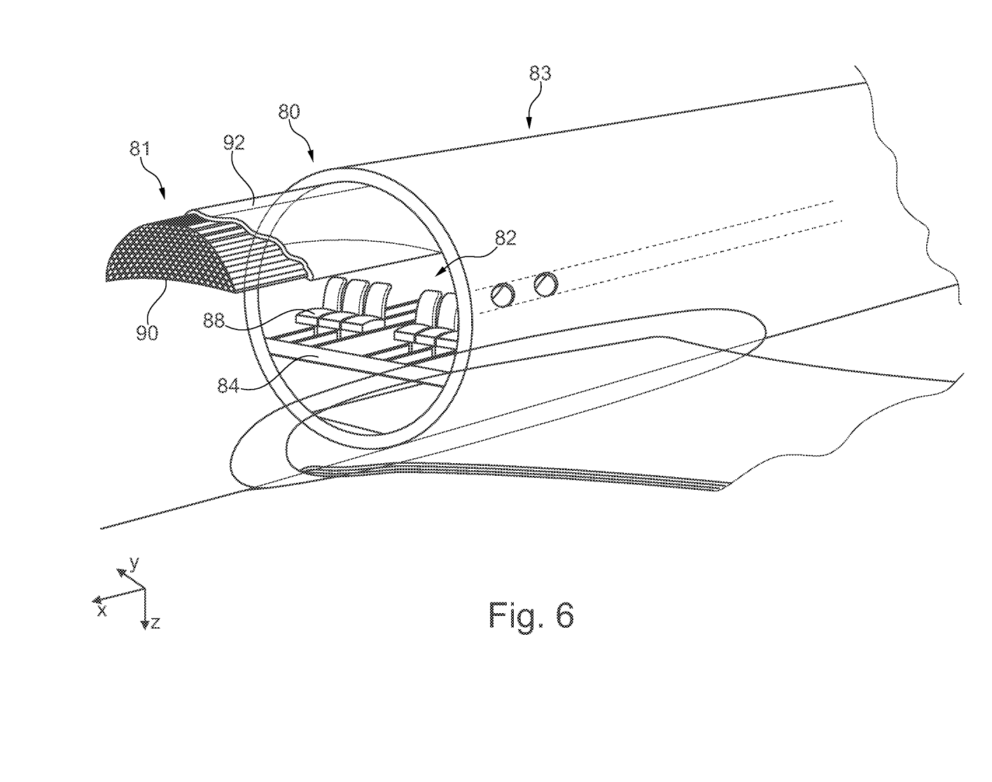

FIG. 6 shows part of an aircraft fuselage 80 that comprises a passenger cabin 82 with a floor 84 and a cabin ceiling 86 in which passenger seats 88 are arranged. The region arranged above the cabin ceiling 86 is referred to as the “crown area”; it may comprise installations, essentially, however, it is a hollow body that adjoins the primary structure of the aircraft fuselage 80. The crown area may comprise an arrangement of individual pressure vessels 90 that are arranged parallel to the aircraft's longitudinal axis (x) and are enclosed by shared insulation 92.

The pressure vessels 90 may practically extend over the entire length of the cabin and can thus have a center of gravity which in the longitudinal direction (x) coincides with the center of gravity of the aircraft. Because of the exposed position in the crown area, according to the invention the arrangement comprising pressure vessels 90 may be designed such that support of the primary structure in this region is achieved. For example, a tank structure 81 formed with it may be connected to the aircraft fuselage 80 in such a manner that, for example, there is no longer any need to provide longitudinal stiffening elements in this region, or that the density of such stiffening elements is reduced.

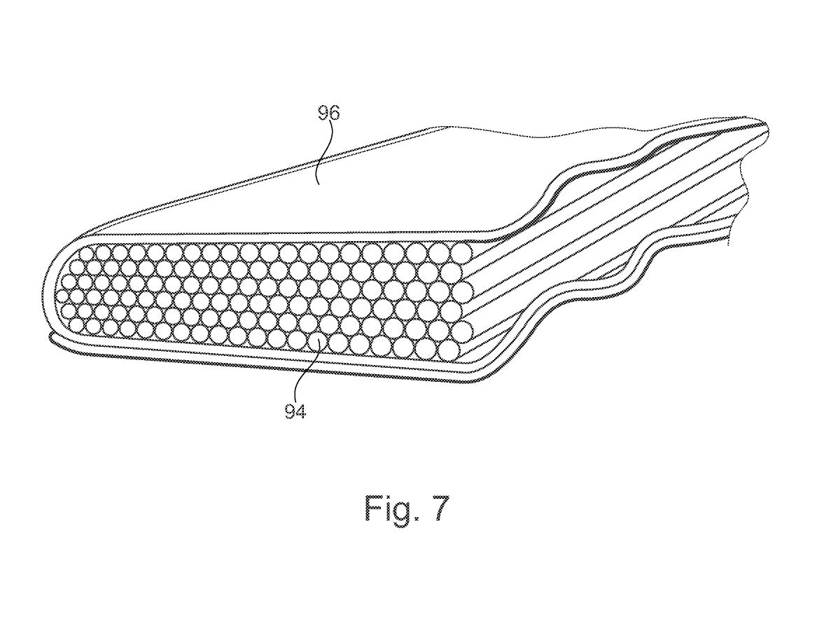

FIG. 7 shows a design from FIGS. 5 and 6 in greater detail. The diagram shows individual tubular pressure vessels 94 that are densely packed and as a result of stacking and corresponding longitudinal dimensions generate the desired shape. It is not necessary to provide each individual one of these pressure vessels 94 with its own insulation. Instead, the totality may be enveloped by an insulating means 96. The latter comprises, in particular, vacuum insulation with spacers integrated therein, which spacers separate an interior envelope from an exterior envelope. Depending on the size of the pressure vessels 94, i.e. diameters and lengths, practically any desired shape that is based on a tubular package can be implemented.

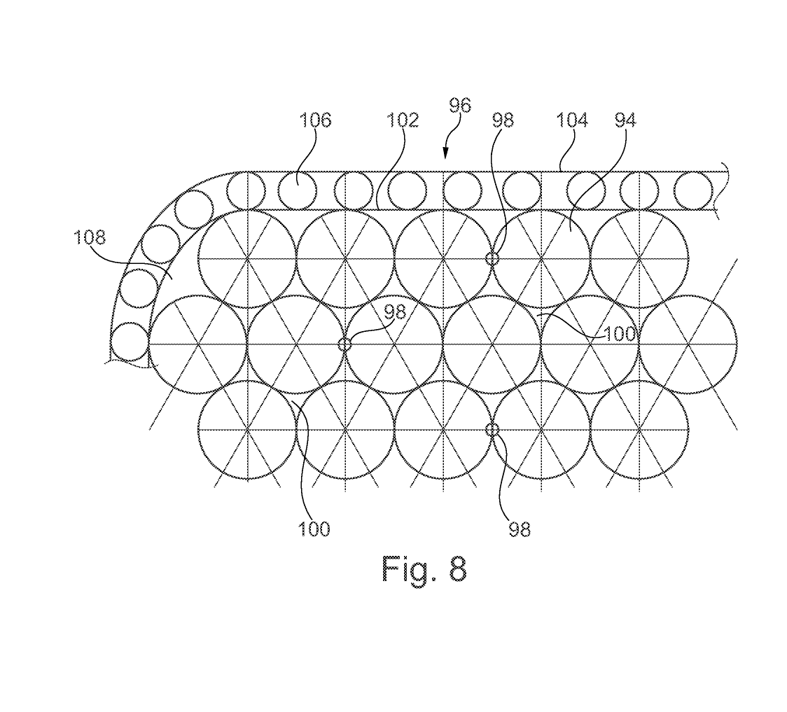

As shown in FIG. 8, individual pressure vessels 94 may be bonded together on facing boundary surfaces 98. This results in interspaces 100 with approximately triangular cross sections that may also be used for storing hydrogen. In this arrangement the bonded-together boundary surfaces may cause the interspaces 100 to be sealed off.

The insulating means 96 comprises an interior envelope 102 and an exterior envelope 104 that are spaced apart from each other by spacers 106. The vacuum that may be generated therein is a particularly good insulator and may, at least for a predetermined period of time, maintain the desired very low temperature level in the pressure vessels 94.

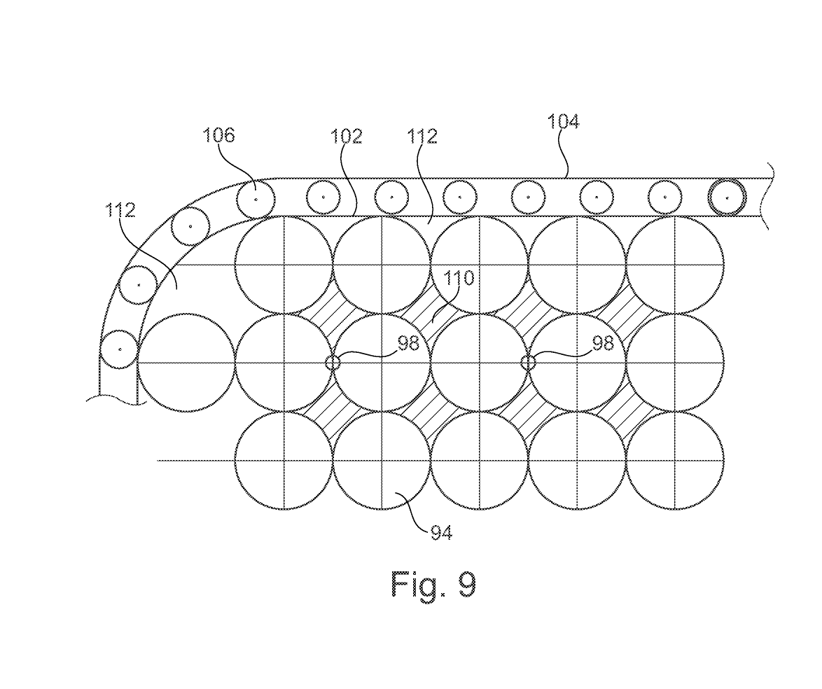

Interspaces 108 that are situated directly between the interior envelope 102 and the exterior pressure vessels 94 are preferably also evacuated in order to still further improve the insulation effect. As shown in FIG. 9 it is not mandatory to achieve a dense package; instead, the individual pressure vessels 94 may also form a uniform matrix-shaped grid in which the longitudinal axes of stacked pressure vessels 94 are always in the same plane. Consequently, interspaces 110 form between the pressure vessels 94, which interspaces 110 essentially comprise a quadrangular lozenge-shaped cross section and may also be used for the storage of hydrogen. In this exemplary embodiment, too, exterior interspaces 112 exist that adjoin the interior envelope 102 of the insulating means 96 and, for the purpose of improving the efficiency of the insulating means 96, are also evacuated.

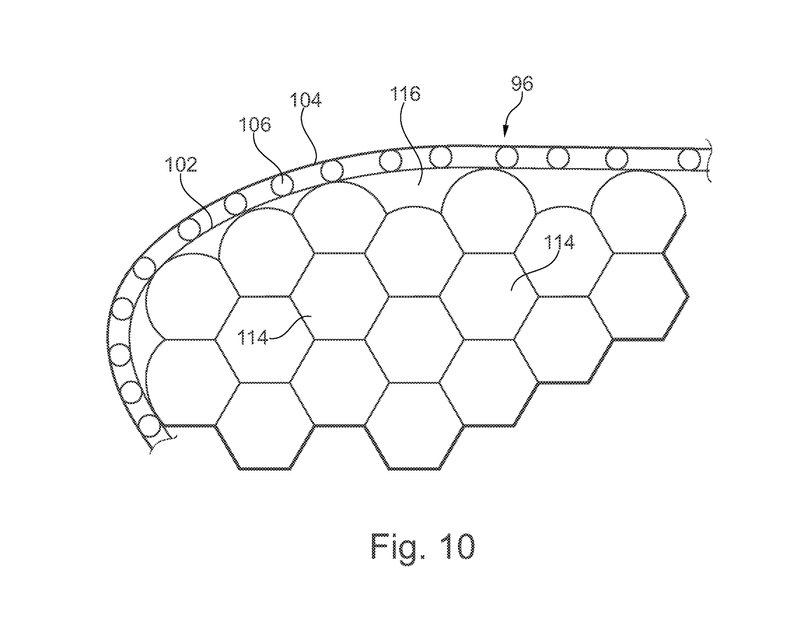

FIG. 10 shows an improvement of the exemplary embodiments of FIGS. 7 to 9. Here, pressure vessels 114 are shown that are based on a hexagonal profile. As a result of the regular and symmetric design of the profiles of the individual pressure vessels 114 it is possible to completely eliminate interspaces in the interior. It may make sense to also evacuate the interspaces 116 that arise towards the exterior to the insulating means 96.

The individual pressure vessels 114 may be bonded at their boundary surfaces facing each other. The design of the material of the pressure vessels 114 may result in the formation of instances of self-rounding 118 so that the pressure vessels 114 conform to the interior envelope 102.

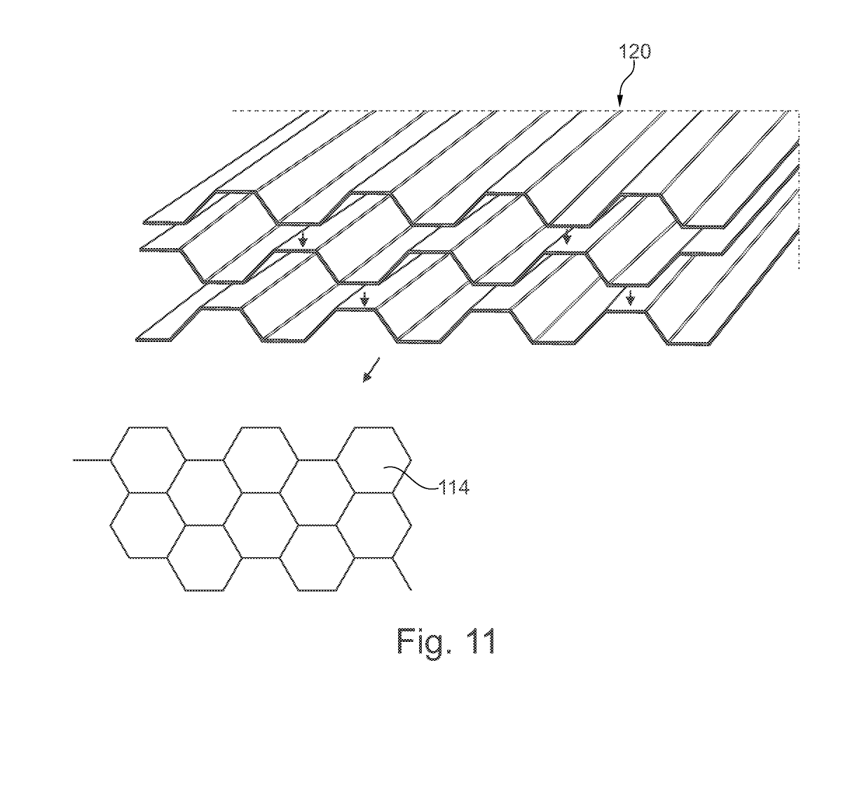

FIG. 11 shows the manufacture of such an arrangement of pressure vessels 114. Manufacture may take place by means of trapezoidal metal sheets 120 that for the purpose of forming a honeycomb structure are placed on top of each other and are bonded or welded together.

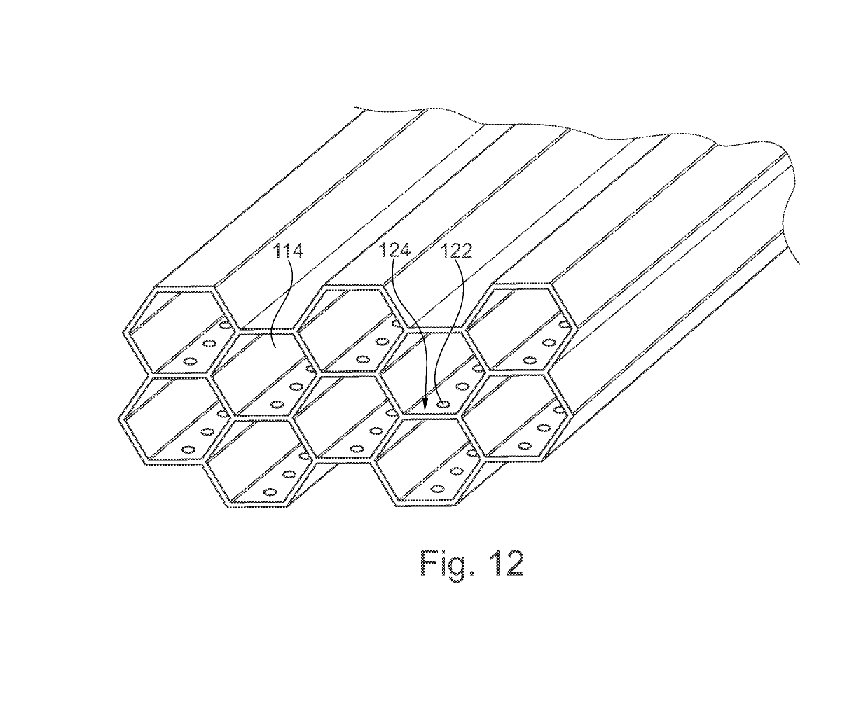

For connecting the individual pressure vessels 114 FIG. 12 shows the integration of perforation apertures 122 on facing surfaces 124 of the individual pressure vessels 114. The perforation openings 122 may be provided at regular spacing on boundary surfaces of the hexagonal profiles. As an alternative, the use of a small number of perforation apertures 122 would be imaginable, which perforation apertures 122 are, for example, arranged only in the end regions of the individual pressure vessels 114.

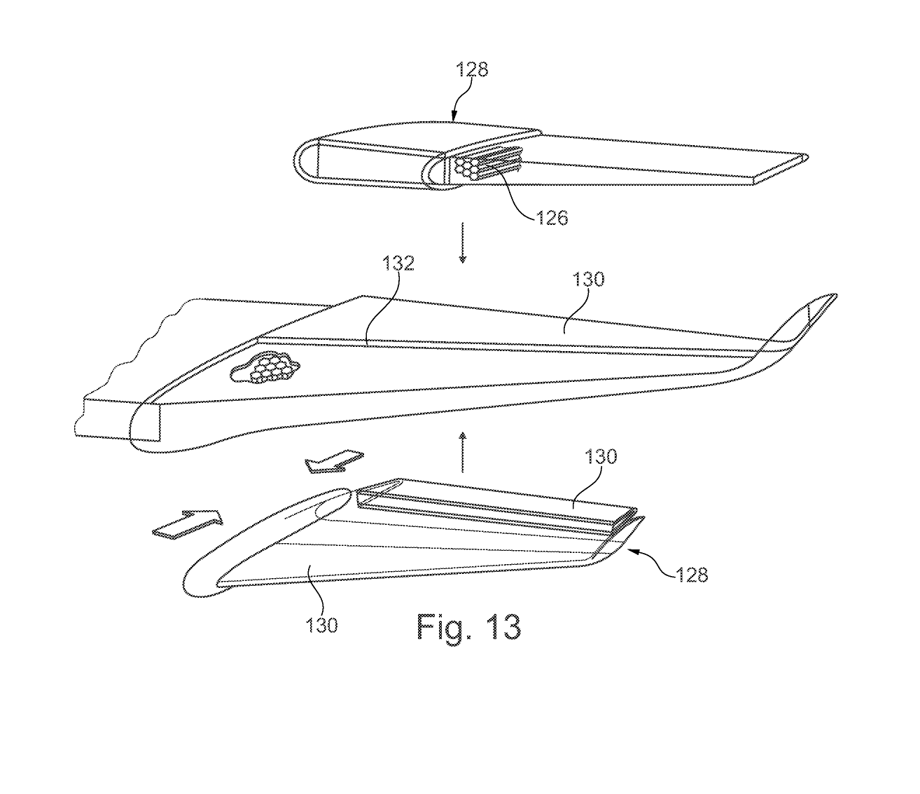

As already mentioned, for the thermal insulation of a tank structure particularly preferably vacuum insulation is used. This requires an adequate space between an interior envelope and an exterior envelope. With reference to an exemplary tank structure 126 in a wing 128, FIG. 13 shows that preformed envelopes 130 with a honeycomb core may be slid over the pressure tank 126, whereupon a seam 132 between two slid-together envelopes 130 may be closed with the use of an adhesive or the like. The honeycomb cores make it possible to achieve stable and reliable spacing of an interior envelope from an exterior envelope.

The use of such a honeycomb core material suggests itself because very good compressive strength is achieved if the webs rest orthogonally on the pressure tank 126 so that evacuation of an interior envelope and of an exterior envelope, which envelopes enclose the honeycomb core, does not lead to mechanical damage to said core. Moreover, the specific weight of such a honeycomb core structure is relatively light, and depending on the dimensions of the individual honeycombs this structure may very easily be made to a desired shape.

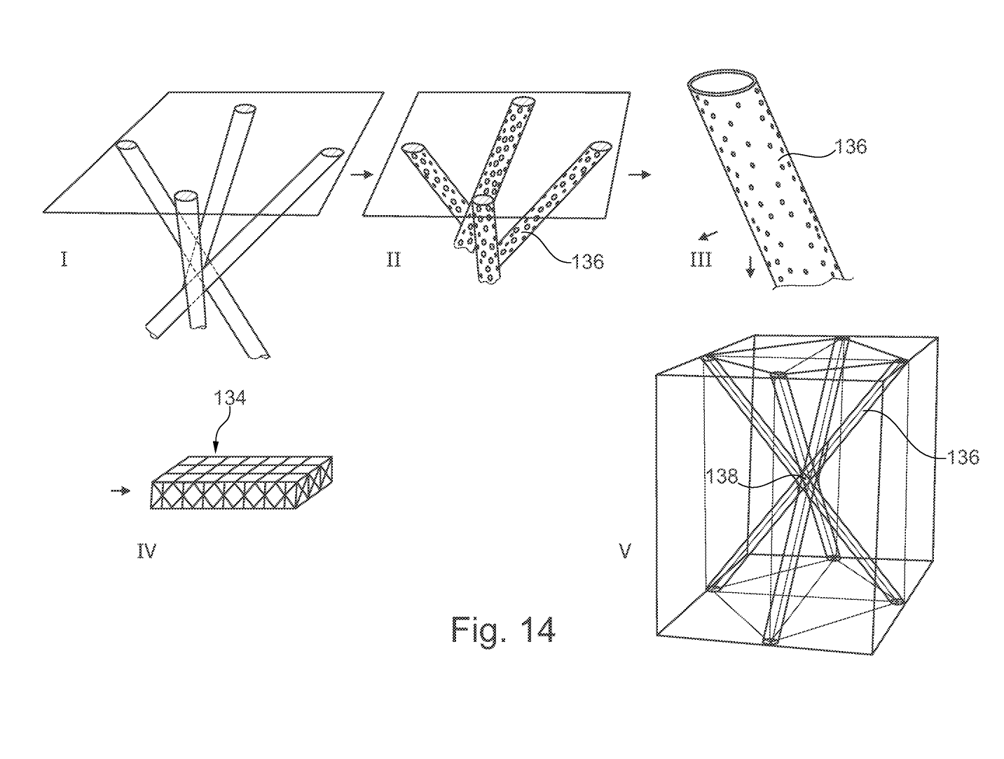

FIG. 14 shows a particular exemplary embodiment with individual manufacturing phases designated I to IV, with the diagram showing a three-dimensional micro-grid 134 comprising several hollow micro-tubelets that in groups coincide in a nodal point 138 from where they extend in three spatial directions. Depending on the angle between the individual micro-tubelets, statically extremely stable lattice structures result that may be used to support tank structures. Apart from its particularly good rigidity, the micro-grid features particularly light weight.

Such a micro-grid structure may, in particular, be constructed with the use of a method based on stereo lithography. A three-dimensional template, for example made of polymer, may be produced by means of stereo lithography. By means of galvanic application of a metal layer, for example comprising a nickel-phosphorus-alloy, correspondingly oriented tubes arise in the three-dimensional template. After the etching-out of the polymer, the hollow micro-tubes remain, which comprise a particularly light weight. Particularly preferably four micro-tubes extend from shared nodal points to two facing delimiting surfaces of an imaginary cuboid formed around a nodal point.

As explained above, such a micro-grid structure may also be produced with the use of a generative manufacturing method. This type of manufacturing method is based on the single or multiple carrying-out of process steps for the layerwise buildup of the desired component, which steps comprise at least the application of a layer section with predetermined dimensions of a particle-shaped material in a predetermined region on a base layer, and the heating of the layer section by means of a heat source in such a manner that the particles of the material combine within predetermined dimensions. In this context the term “base layer” refers to a layer that is present prior to each application of a further layer. This makes it possible to achieve particularly lightweight and strong components of practically any complexity of shape.

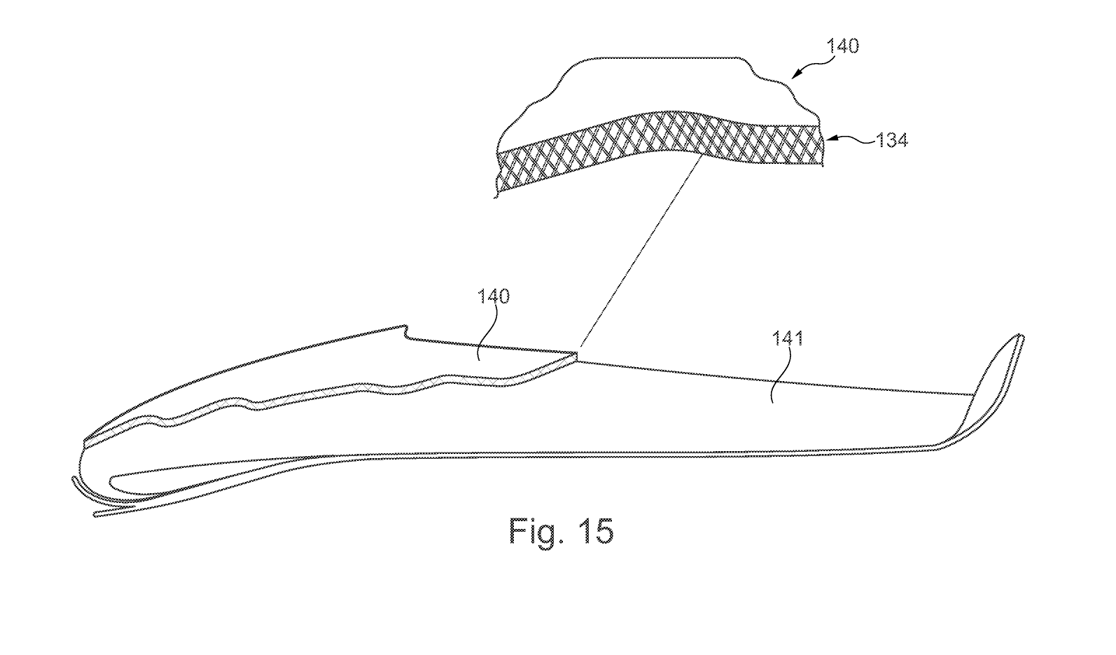

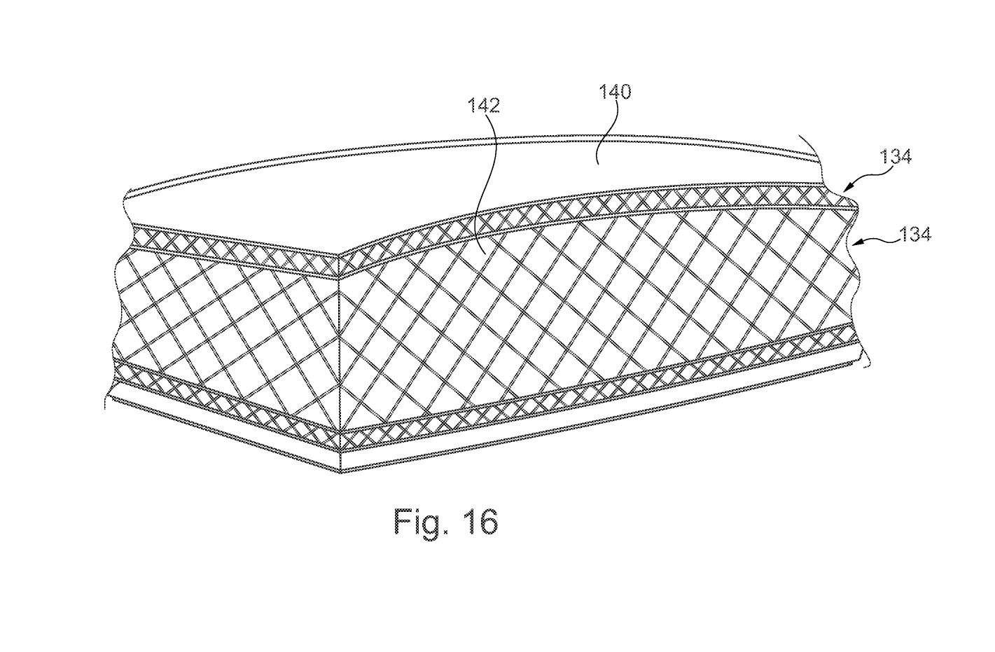

As shown in FIGS. 15 and 16, such a micro-grid structure may not only support the insulating means 140, i.e. space apart an interior envelope from an exterior envelope, but also support a pressure tank 142. In the use as an evacuated insulation envelope, as small-structured a grid as possible should be used, which grid is, in particular, subjected to pressure by the pressure vessels. In the pressurized interior of the tank, preferably a large-structured grid should be used, wherein the tubelets arranged therein are subjected to tension.

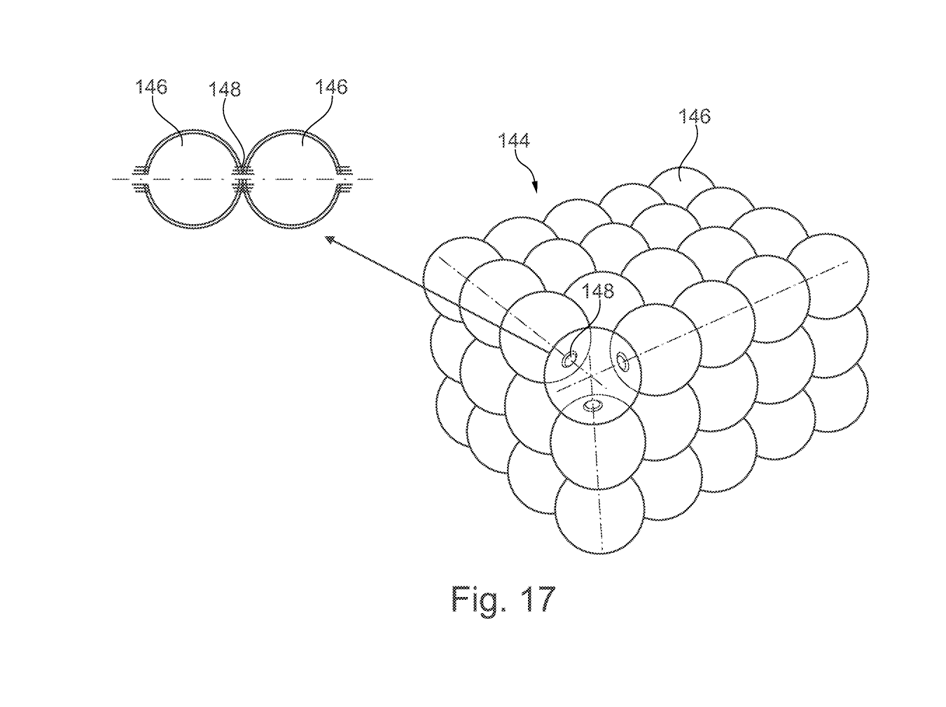

FIG. 17 shows a tank structure 144 comprising several spherical pressure vessels 146 that are interconnected by means of apertures 148. The tank structure 144 may comprise either a matrix-shaped arrangement, as shown in FIG. 17, or a dense spherical pack.

A particular advantage can be achieved by selective and consecutively occurring emptying of the layers of a spherical pack from the exterior to the interior. As a result of this, from the exterior to the interior empty layers of the spherical pack occur, similar to the manner of an onion-skin principle, which layers have an insulating effect on the further inwards positioned layers, thus supporting insulation (not shown) that encloses the tank structure 144. Insulation may also take place almost exclusively as a result of this principle, and consequently, wherever possible, the aircraft is refueled only directly prior to the flight, and the inevitably evaporating hydrogen is led from the exterior layers directly to the engines and to other consumers.

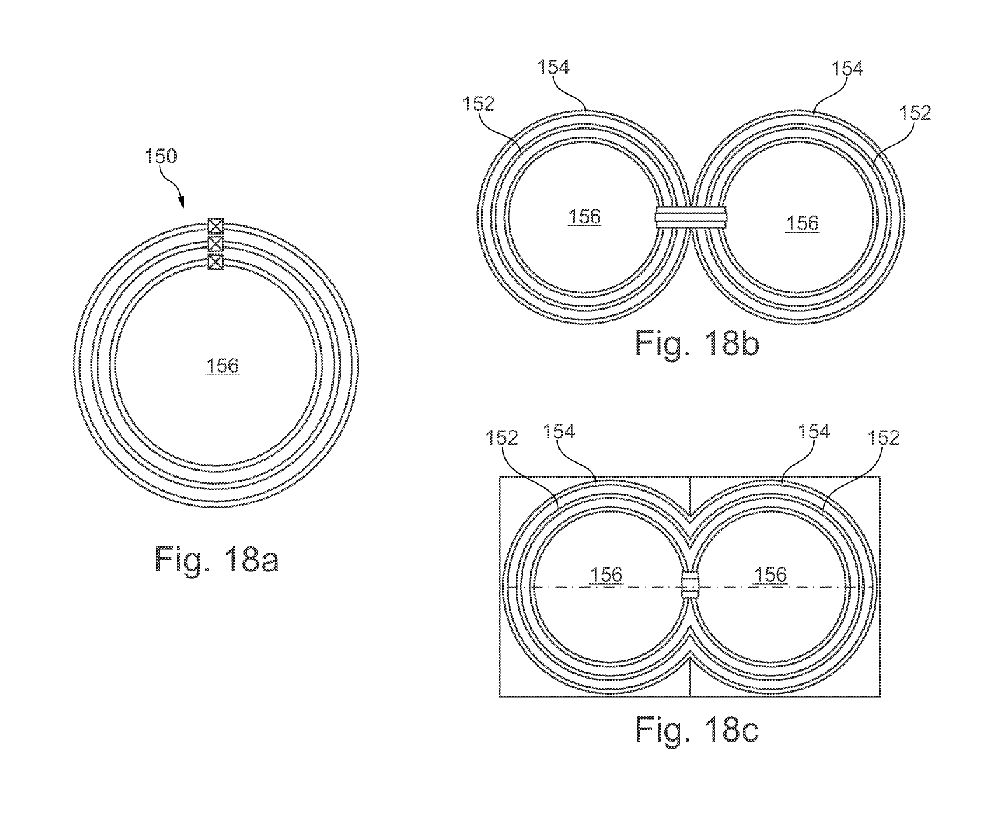

The spheres that form spherical layers may be insulated and interconnected based on several different principles, as is shown in FIGS. 18a to 18c. FIG. 18a shows a sphere 150 with two envelopes 152 and 154 with insulation, wherein from a core volume 156 hydrogen may, by way of valves 158, flow from the core volume 156 to the exterior, for example to an adjacent sphere 150, to an interspace or to a line.

FIG. 18b shows two insulated spheres 160 whose core volumes 156 are connected to envelopes 152 and 154 that are separate of each other.

In FIG. 18c the core volumes 156 and the envelopes 152 and 154 are interconnected.

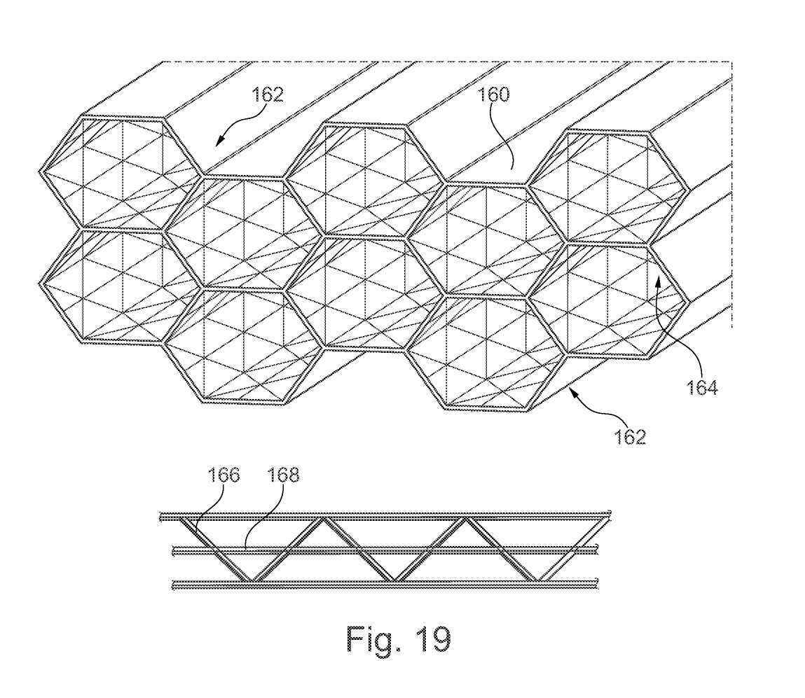

Finally, FIG. 19 shows an arrangement of pressure vessels 160 that are based on tubes with hexagonal profiles that at the same time comprise a lattice structure 162, which is similar to that of FIG. 14 except that it is designed in the shape of flat substructures that are delimited in a ribbon-like manner. It is a core idea in this concept to penetrate areas of these tubes that do not correspond to exterior walls 162, but instead to interior walls 164, and to replace them by a set of tie bars 166 and 168 which form, for example, a regular arrangement of triangles in the manner of a framework structure in the shape of a ribbon that may replace a delimitation wall of a hexagon profile.

At the same time, tie bars 168 that extend so as to be parallel to the longitudinal extension are used to improve tensile strength, in particular in the longitudinal direction. Overall, with this design a particularly strong structure that nevertheless is extremely light in weight may be produced that results in a particularly advantageous pressure tank.

In addition, it should be pointed out that “comprising” does not exclude other elements or steps, and “a” or “one” does not exclude a plural number. Furthermore, it should be pointed out that characteristics which have been described with reference to one of the above exemplary embodiments can also be used in combination with other characteristics of other exemplary embodiments described above. Reference characters in the claims are not to be interpreted as limitations.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tank system for the cryogenic storage of hydrogen, the tank system comprising:
a tank structure with at least one hollow body for accommodating liquid hydrogen; and
at least one insulating means enclosing the tank structure, for insulating the at least one hollow body;
wherein the tank structure comprises an exterior shape that is integratable in a load-bearing primary structure of an aircraft, and
wherein the tank structure is load bearing and is configured to at least partially absorb a load introduced into the primary structure.

2. The tank system of claim 1, wherein the at least one hollow body comprises an arrangement of a plurality of closed-off pressure vessels which in each case comprises at least one aperture in fluidic communication with an aperture of an adjacent pressure vessel.

3. The tank system of claim 2, wherein the arrangement of the plurality of closed-off pressure vessels is an arrangement of a plurality of interconnected elongated tubes of a round or polygonal cross section.

4. The tank system of claim 3, wherein the tubes comprise a hexagonal profile and are configured to form a dense package without interspaces.

5. The tank system of claim 3, wherein at least one wall of at least one tube, that is not an exterior wall comprises a lattice structure at least in some regions.

6. The tank system of claim 3, wherein the tubes are stacked parallel to each other in a dense package, and
wherein the shape of the tank structure is determined by the sequence of the parallel layers and by the lengths of the individual tubes.

7. The tank system of claim 2, wherein the arrangement of the plurality of closed-off pressure vessels is an arrangement of a plurality of interconnected spherical vessels.

8. The tank system of claim 2, wherein adjacent pressure vessels are bonded together.

9. The tank system of claim 3, further comprising a gas-proof and evacuated envelope enclosing the arrangement of pressure vessels so that the pressure vessels are enclosed flush by the envelope and as a result of the evacuation are pressed together to form a solid bundle.

10. The tank system of claim 4, wherein interspaces between adjacent pressure vessels are gas-proof and are configured to receive or deliver hydrogen as required.

11. The tank system of claim 1, wherein the at least one hollow body comprises an exterior wall extending over a spatial lattice structure.

12. The tank system of claim 11, wherein the lattice structure comprises groups of struts arranged at angles to each other, wherein each group comprises a common nodal point, and outwards-projecting struts of adjacent groups are interconnected.

13. An aircraft, comprising:
a fuselage;
at least one wing;
at least one hydrogen-consuming device; and
at least one tank system for storing cryogenic hydrogen, the tank system comprising:
a tank structure with at least one hollow body for accommodating liquid hydrogen; and
at least one insulating means enclosing the tank structure, for insulating the at least one hollow body;
wherein the tank structure comprises an exterior shape that is integratable in a load-bearing primary structure of an aircraft, and
wherein the tank structure is load bearing and is configured to at least partially absorb a load introduced into the primary structure.

14. The aircraft of claim 13,
wherein the tank system is integrated in the at least one wing,
wherein the tank structure comprises a plurality of tubes interconnected and stacked in a layered manner, and
wherein the at least one insulating means encloses the entire arrangement of the tank structure.

15. The aircraft of claim 14, wherein the tubes are arranged orthogonally to the leading edge of the wing, parallel to the longitudinal direction of the aircraft or parallel to the leading edge of the wing and comprise at least two different lengths in order to assume a shape matching the contour of the wing.
